(19) United States
(12) Patent Application Publication
(10) Pub. No.: US 2010/0260596 A1
(43) Pub. Date: Oct. 14, 2010

(54) Hydraulic bulb turbine with mixed-flow propeller runner

(76) Inventor: Alexander Gokhman, San Francisco, CA (US)

Correspondence Address: ALEXANDER GOKHMAN, 3031 NORIEGA STREET, SAN FRANCISCO, CA, 94122-4151, US

(21) Appl. No.: 12/386,011

(22) Filed: Apr. 13, 2009

(51) Int. Cl. F03B 3/18; F03B 13/26

(52) U.S. Cl. 415/160; 290/53

(57) ABSTRACT

The invention is a Bulb turbine with mixed-flow propeller runner instead of axial flow propeller runner. The main area of application for the invention are the large tidal power plants (Fundy Bay, Severn Lake, etc.) with barrages where the propeller runners are working together with DC generators located in the bulbs.

The theoretical fluid mechanical and energy output analyses show that the application of Bulb turbine with mixed-flow propeller and (Q₁₁)ₒₚₜ=2.830 m³/sec would increase the energy output of the Fundy Bay tidal power plant with 200 units up to 4.5 million megawatt-hours per year in comparison with commercially available Bulb turbines with axial flow propellers and (Q₁₁)ₒₚₜ=2.200 m³/sec without additional cost for the plant construction and its equipment.

Also, the runner rotation of Bulb turbines with mixed-flow propellers [(N₁₁)ₒₚₜ=110.0 rpm, Nₒₚₜ=50.807 rpm] is 0.667 times slower than of commercially available Bulb turbines [(N₁₁)ₒₚₜ=165.0 rpm, Nₒₚₜ=76.211 rpm] what makes these turbines fish friendlier than the commercially available Bulb turbines with axial flow propellers.

### BACKGROUND OF THE INVENTION

This invention relates to turbine equipment for low head hydro-power plants and tidal power plants with a barrage. More specifically to the bulb turbines. Bulb turbines with axial flow runners are considered today as the best turbines for the low head conventional hydro-power plants.

The Bulb turbine for low head hydro-power plant is equipped with adjustable blade axial runner (Kaplan runner). This turbine has high peak efficiency and can work with moderately decreased efficiency and low level of the pressure pulsations in draft tube cone in operating regimes with heads, H, and powers, P, different from optimal [0.60Hₒₚₜ≦Hₒₚₜ≦1.40Hₒₚₜ, 0.50Pₒₚₜ≦Pₒₚₜ≦Pₘₐₓ=Pₘₐₓ(H)].

The requirements to the turbine equipment for tidal power plants are very much different from the requirements to the turbines for conventional low head hydro-power plants, because these plants are essentially different.

In order to generate the power a conventional low head hydro-power plant uses the flow in the river partially stored in the upper reservoir and the head formed by the dam. The upper reservoir enables this power plant to the planned changes in flow and head. If the plant is equipped with sufficient number of properly selected turbines the water stored in the upper reservoir is never lost excluding the case of catastrophic flood. The best turbine for this plant from the point of energy output is the Bulb turbine with Kaplan runner connected to the synchronous generator, because it works with high efficiency and small pressure pulsations in draft tube in the sufficiently wide range of variations in the plant head and power output.

The tidal power plant with the barrage generates the power in different manner. The power house of the tidal power plant with barrage, separating the basin from the ocean, is the integral part of the barrage. There are two types of tidal power plants with barrage. Ebb generation tidal power plant and two-way generation tidal power plant. Ebb generation tidal power plant generates the power by storing the ocean water in the basin during the flood passing it to the basin via sluices installed in the barrage and during the ebb passing through the power house turbines the water stored in the basin. Two-way generation tidal power plant, with same number of one-way turbines as ebb-generation tidal power plant (Two-way generation tidal power plant with one-way turbines, UK Patent GB 2 436 857 B, 20 Feb. 2008, Inventor: Alexander Gokhman), generates the power by filling and emptying the basin by passing the ocean water through the power house turbines during the flood and the ebb correspondingly. There are two ebb and flood cycles per diem. It is clear that in order to completely utilize the energy of the tide the ebb generation plant must completely empty the basin during the ebb via turbines. Similarly the two-way generation plant to completely utilize the energy of the tide must completely empty and fill the basin via turbines during the flood and the ebb correspondingly. There are two problems not allowing to completely utilize the tide energy at tidal plants of both types.

The first problem is that the head at ends of ebb/flood generation is reaching zero and the Kaplan runner connected to synchronous generator cannot work at the heads bellow 25% of maximum head and this leads to underutilization of the tide energy. As the result Bulb turbines for tidal power plants are consider now to be equipped instead of Kaplan runners with axial propellers and are connected to DC generators with power converters to alternative current of standard frequency. The units comprising the Bulb turbines with axial propeller runners connected to DC generators can work for all heads at the optimal operating regime [Q₁₁=(Q₁₁)ₒₚₜ, N₁₁=(N₁₁)ₒₚₜ]. However, this unit cannot increase the value Q₁₁ for the operating regimes with heads smaller than maximal head, H<Hₘₐₓ, what do not allow it to fully utilize the energy of the tide. This problem was recently solved by considering this unit equipped with Exit Stay Apparatus (Hydraulic Turbine and Exit Stay Apparatus therefor, U.S. Pat. No. 6,918,744 B2, Jul. 19, 2005, Inventor: Alexander Gokhman). The Exit Stay Apparatus allows to the Bulb turbine with axial propeller runner to work at operating regimes [Q₁₁>(Q₁₁)ₒₚₜ, N₁₁=(N₁₁)ₒₚₜ] with high efficiency and acceptable pressure pulsations in draft tube. In this connection it is important to mention that this unit works with Q₁₁>(Q₁₁)ₒₚₜ at the heads, H<Hₘₐₓ and bigger absolute value of the submergence of turbine axis, (Hₛ)ₐₓ, providing the absence of cavitation at these operating regimes.

The second problem is that with existing at present time maximum values for the Bulb turbine runner diameter, Dₜ=7.50 m, and for unit flow rate at optimum, Qₒₚₜ=2.20 m³/sec, it is necessary to have very many units in order not to under-utilize the tide energy. Especially it is true for future tidal power plants like Fundy Bay in Canada and Severn Estuary in UK with very large basin volumes. For example in order to properly utilize the tide energy at Fundy Bay it is necessary to consider the tidal power plant at list with 350 units. It is clear that such a number of units with Dt=7.5 m leads to extremely high capital investment into tidal plant construction. As a mater of fact the project of Fundy Bay tidal power plant developed in 1976-1977 was considering only 160 units and that lead to the drastic underutilization of the tide energy.

### BRIEF SUMMARY OF THE INVENTION

The present invention discloses a Bulb turbine with mixed-flow propeller runner which has the radius at inlet of the crown cascade substantially bigger than in the Bulb turbine with axial flow propeller runner of the same diameter. This difference in the radii at inlet of the crown cascade leads to the essential differences between Bulb turbine with axial flow and mixed-flow propeller runners. In the axial flow propeller runner the critical point of cavitation is located at the crown/hub with high value of absolute velocity circumferential component Vᵤ, but in mixed flow propeller the critical point of cavitation is located at the periphery with high value of ωR and small value of Vᵤ. When working together with DC generator located in the bulb of turbine a Bulb turbine with mixed-flow propeller is superior to a Bulb turbine with axial propeller by the flow discharge capacity for the same value of submergence, Hₛ, guarantying cavitation free work.

The analyses (using developed by me programs INNA and ENERGY) of commercially available Bulb turbine with axial flow propeller having [(Q₁₁)ₒₚₜ]_{mf}=2.2 m³/sec, [(N₁₁)ₒₚₜ]_{mf}=165 rpm and the Bulb turbine with mixed-flow propeller having [(Q₁₁)ₒₚₜ]_{mf}=2.83 m³/sec, [(N₁₁)ₒₚₜ]_{mf}=110 rpm permitted to come up with following conclusions.

Application of Bulb turbine with mixed-flow propeller and (Q₁₁)ₒₚₜ=2.83 m³/sec would increase the energy output of the Fundy Bay tidal power plant with 200 units up to 4.5 million megawatt-hours per year in comparison with commercially available Bulb turbine with axial flow propeller and (Q₁₁)ₒₚₜ=2.20 m³/sec without additional cost for the plant construction and its equipment.

The runner rotation of the Bulb turbines with mixed-flow propellers [(N₁₁)ₒₚₜ=110.0 rpm, Nₒₚₜ=50.807 rpm] is 0.667 times slower than of commercially available Bulb turbines [(N₁₁)ₒₚₜ=165.0 rpm, Nₒₚₜ=76.211 rpm] what makes these turbines fish friendlier than the commercially available Bulb turbines with axial flow propellers.

### BRIEF DESCRIPTION OF THE SEVERAL VIEWS OF THE DRAWINGS

FIG. 1 is an elevation view, partially in cross-section, of a power house of a barrage tidal power plant with a Bulb turbine having a mixed-flow propeller runner and an exit stay apparatus by a vertical plane passing through the turbine axis.

FIG. 2 is a view of a major fragment of the water passages for a Bulb turbine shown in FIG. 1. The fragment includes a part of a bulb, a conical distributer with diagonal wicket gates, a mixed-flow propeller runner, a discharge ring with an exit stay apparatus, and a draft tube cone.

### DETAILED DESCRIPTION OF THE INVENTION

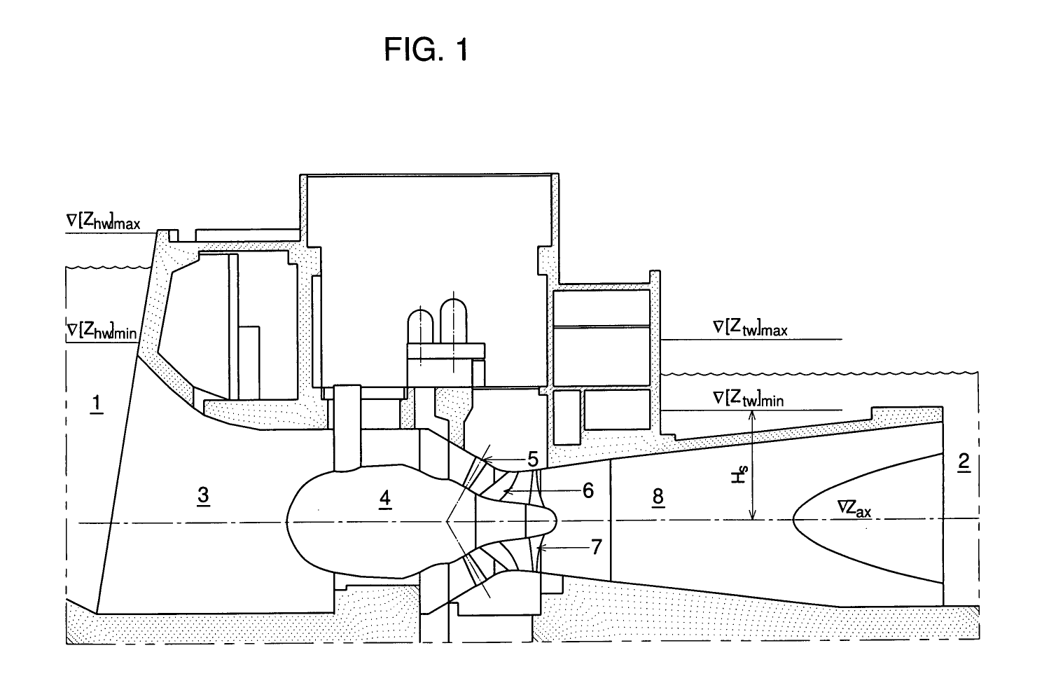

FIG. 1 shows an elevation view, partially in cross-section, of a power house of a barrage tidal power plant with a Bulb turbine having a mixed-flow propeller runner and an exit stay apparatus by a vertical plane passing through the turbine axis. The Bulb hydraulic turbine presented in FIG. 1 has an intake 3 connected with head water 1, a bulb 4 with an electrical DC generator inside, a conical distributer with diagonal wicket gates 5, a mixed-flow propeller runner 6, an exit stay apparatus 7, and a draft tube 8 connected with tail water 2. It is clear that the Bulb turbine presented in FIG. 1 is different from the well known Bulb turbine for tidal power plants with barrage by comprising a mixed-flow propeller runner 6 instead of an axial flow propeller runner and also by having an exit stay apparatus 7 allowing the turbine to work at unit flow, Q₁₁, bigger than the optimal unit flow, (Q₁₁)ₒₚₜ, with high efficiency and small pressure pulsations in draft tube 8. FIG. 1 shows the following levels:
∇[Z_{hw}]ₘₐₓ—the maximal head water level,
∇[Z_{hw}]ₘᵢₙ—the minimal head water level,
∇[Z_{tw}]ₘₐₓ—the maximal tail water level,
∇[Z_{tw}]ₘᵢₙ—the minimal tail water level,
∇Zₐₓ—the turbine axis level.
   Also FIG. 1 shows the submergence of the turbine axis below the minimal tail water level, Hₛ=∇Zₐₓ−∇[Z_{tw}]ₘᵢₙ. The value of Hₛ shown in FIG. 1 is not required by cavitational properties of the turbine but by the condition that the upper end of draft tube exit must be submerged below ∇[Z_{tw}]ₘᵢₙ. I will designate this value of Hₛ as mandatory submergence Hₛₘ. The Bulb turbine presented in FIG. 1 has the runner diameter, D₁=7.5 m and is drawn in scale=1/650. As can be seen from FIG. 1 Hₛₘ=−8.23 m

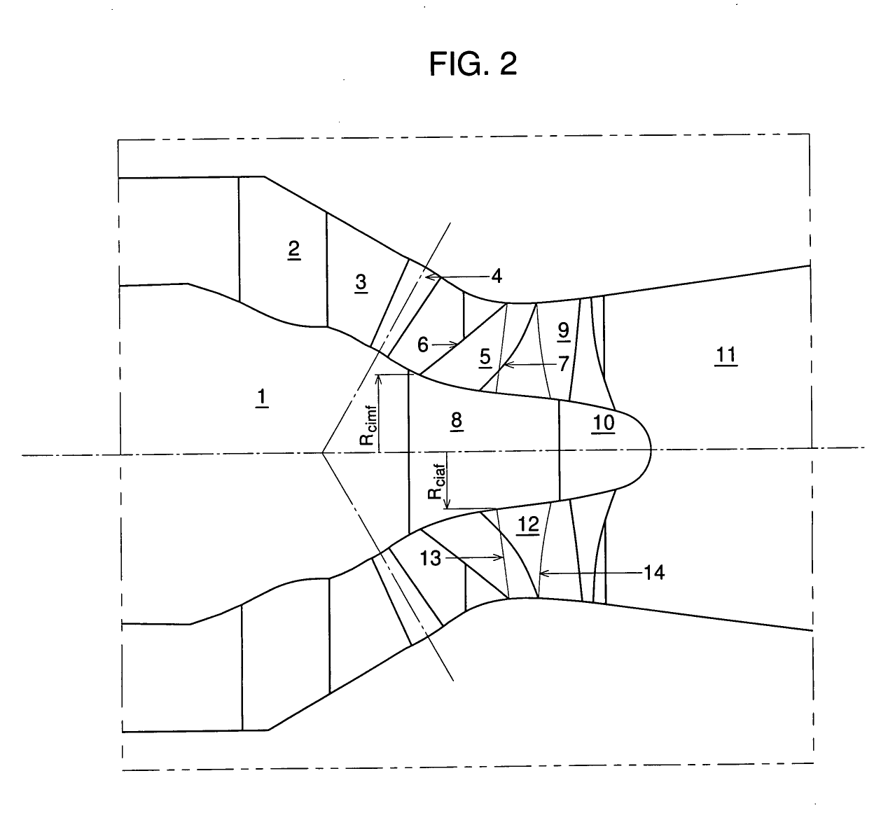

FIG. 2 shows a major part of the water passages for a Bulb turbine shown in FIG. 1. In FIG. 2 the flow is passing around a bulb 1 and via supporting the bulb 1 stay vanes 2 is coming through a conical distributor 3 with diagonal wicket gates 4. After that the flow is passing a mixed-flow runner blades 5 secured to a runner crown 8 and freely rotating inside a discharge ring 9. The runner blades 5 have inlet edges 6 and exit edges 7. An exit stay apparatus 10 is located after the runner crown 8 and is secured on the periphery to a discharge ring 9. Finally the flow after passing the exit stay apparatus 10 is entering a draft tube cone 11. FIG. 2 also shows in thin lines runner blades 12 of an axial flow propeller runner if the bulb turbine shown in FIG. 1 was fitted with this runner. The runner blades 12 have inlet edges 13 and exit edges 14. FIG. 2 shows the following radii:
R_{cimf}—the inlet radius of the crown cascade for mixed-flow propeller,
R_{ciaf}—the inlet radius of the crown cascade for axial propeller.
   It is easy to see in FIG. 2 that R_{cimf} is significantly bigger than R_{ciaf}. As will be shown below this difference in inlet radii at crown profiles causes the essential difference between Bulb turbines with mixed-flow propeller and axial propeller.

It is easy to see that the Bulb turbines with mixed-flow and axial flow propellers have significantly different values of N₁₁ allowing the high value of the peak efficiency ηₘₐₓ. Let us consider the flow at the inlet to crown cascade profile of the turbine with D₁=1 m working under H=1 m. It is well known that at optimal operating regime the value of the whirl at the crown profile exit is zero, (VuR)_{ce}=0, and, therefore, the whirl at the crown profile inlet, (VuR)_{ci}=∇(VuR). The value of ∇(VuR) at optimum is defined by Euler's equation:

$$Δ ( {V}_{u} R ) = \frac{g {η}_{max} H}{ω} \qquad ( 1 )$$

where:
ω=πN/30 is the angular velocity of the runner rotation and
g is the gravity
   Therefore, the circumferential component of relative velocity at the crown profile inlet of runner:

$${( {W}_{u} )}_{ci} = \frac{g {η}_{max} H}{ω {R}_{ci}} - ω {R}_{ci} \qquad ( 2 )$$

where:
R_{ci} is the inlet radius of the crown cascade
   So the critical value of ω, corresponding to (Wᵤ)_{ci}=0:

$${ω}_{cr} = \frac{\sqrt{g {η}_{max} H}}{{R}_{ci}} \qquad ( 3 )$$

Or finally the critical value of N₁₁ [N₁₁=(30ωD₁)/(π\sqrt{H})] corresponding to (Wᵤ)_{ci}=0:

$${( {N}_{11} )}_{cr} = \frac{30 \sqrt{g {η}_{max}}}{π {C}_{ci}} \qquad ( 4 )$$

where:
C_{ci}=R_{ci}/D₁ is the relative value of R_{ci}
   It is clear from (2) that in optimal operating regime with (N₁₁)ₒₚₜ<(N₁₁)_{cr} we will have (Wᵤ)_{ci}>0. On the other hand at optimum with (VuR)_{ce}=0 the exit value of relative velocity circumferential component at the crown, (Wᵤ)_{ce}=−ωR_{ce}<0 and the crown profile has the shape of a sickle. It is well known that in a cascade with sickle shaped profiles the flow separates what causes the drastic increase of the profile losses in the cascade.

As far as I know in the Bulb turbine with axial flow propeller C_{ci,af}≦0.20 and, therefore, for ηₘₐₓ≧0.90 from (4) [(N₁₁)_{cr}]_{af}≧141.9 rpm. It is can be seen from FIG. 2, which, as it was mentioned above, is drawn in scale=1/650 that for mixed-flow runner C_{ci,mf}=1.38*C_{ci,af} and, therefore, [(N₁₁)_{cr}]_{mf}≧102.8 rpm.

In this connection it is necessary to say that in the best Bulb turbines with axial flow propellers have the optimal value of unit rotation, [(N₁₁)ₒₚₜ=165.0 rpm. This high value of [(N₁₁)ₒₚₜ is necessary for Bulb turbine with synchronous generator in the bulb in order to make the generator to fit inside the bulb. It is clear that (N₁₁)ₒₚₜ=165.0 rpm is not necessary for DC generator and leads to high profile losses in the axial flow propeller.

It is well known that the relative profile losses of blade cascade in the axial flow propeller runner located at radius, R_{c}:

$${ζ}_{pr} = {C}_{prl} ( L / T ) \frac{{W}_{∞}^{3}}{2 {gHV}_{z}} \qquad ( 5 )$$

where:
Cₚᵣₗ is the coefficient of the profile losses,
W_{∞}=\sqrt{[0.5(Vᵤᵢ+Vᵤₑ)−ωR_{c}]²+V_{z}²}, and
L/T is the cascade solidity
   The formula (5) can be used for comparison of profile losses at optimum in the peripheral cascades of bulb turbines with axial flow and mixed-flow runners. As can be seen in FIG. 2 the radius of the conical wicket gate exit at the periphery, R_{ge,per}=1.84 R_{ge,c}, where R_{ge,c} is the wicket gate exit radius at the crown. So at inlet of peripheral profile [(VuR)ₚᵢ]ₒₚₜ=[(VᵤR)_{ge,per}]ₒₚₜ=1.84Δ(VᵤR)ₒₚₜ, because at optimum (VuR)_{ce}=0, and, therefore, at exit of peripheral profile [(VuR)ₚₑ]ₒₚₜ=[(VuR)ₚᵢ]ₒₚₜ−Δ(VᵤR)ₒₚₜ=0.84Δ(VᵤR)ₒₚₜ. Also as can be seen in FIG. 2 it can be safely accepted that at the values of Z corresponding to the inlet and outlet of the periphery cascade for both axial and mixed-flow propellers (V_{z})ₚₑᵣ=(4Qₒₚₜ)/[πD₁²(1−4C_{ci,af}²)] So finally the formula for relative profile losses in periphery profiles of axial flow and mixed-flow runners can be written:

$${( {ζ}_{pr} )}_{per} = {{C}_{prl} ( L / T )}_{per} \frac{{( {W}_{∞} )}_{per}^{3}}{2 {gH ( {V}_{z} )}_{per}} \qquad ( 6 )$$

where:
Cₚᵣₗ is the coefficient of the periphery profile losses,

$${( {W}_{∞} )}_{per} = \sqrt{{\{ [ 2.68 {Δ ( {V}_{u} R )}_{opt} ] / {D}_{1} - 0.5 ω {D}_{1} \}}^{2} + {( {V}_{z} )}_{per}^{2}} ,$$

and
(L/T)ₚₑᵣ is the cascade solidity on periphery
   It is clear that in order to comprehensively compare the Bulb turbines with axial flow and mixed-flow propellers the values of required submergencies, Hₛ, are necessary.

I computed the necessary for comparison values of Hₛ for Bulb turbines with mixed-flow and axial flow runners using developed by me in 1980-1989 program INNA which is based on the method of singularities. The results of computation of the turbine cavitation coefficient σₜ for numerous vertical Kaplan and Francis turbines were very close to the model test results at Hydro-turbine Devision of Allis-Chalmers Corporation, which now is Voith Siemens at York, Pa., where I was working in 1981-1986, and at different hydro-turbine laboratories when I designed turbine runners for Hydro West Group at Seattle, Wash., in 1990-1997.

In application of the program INNA to the horizontal Bulb turbine the following approach was accepted. Velocity components of absolute and relative flows were computed for N cascades of profiles defining the runner blades at M points for each cascade profile and the cavitation coefficient for the runner blade n-th cascade at the m-th point (R_{n,m}, Z_{n,m}, Φ_{n,m}) of the cascade profile was computed by the well known formula:

$${σ}_{n , m} = \frac{{W}_{n , m}^{2} - {W}_{n , ex}^{2} + {V}_{n , ex}^{2} + {U}_{n , ex}^{2} - {U}_{n , m}^{2}}{2 gH} - {ζ}_{n} \qquad ( 7 )$$

where:
W_{n,m} is the relative velocity at the m-th point of the n-th cascade profile,
W_{n,ex} is the relative velocity at the exit of the n-th cascade profile,
U_{n,m}=ωR_{n,m} (R_{n,m} is the radius of the m-th point n-th cascade profile),
U_{n,ex}=ωR_{n,ex} (R_{n,ex} is the radius of the exit of the n-th cascade profile),
V_{n,ex} is the absolute velocity at the exit of the n-th cascade profile, and
ζₙ is relative head loss between n-th profile exit point and draft tube exit.
   So the cavitation coefficient for the runner blade n-th cascade profile, σₙ is the biggest value of σ_{n,m} (σ_{n,m}≦σₙ, m=1, . . . M) and the critical radius for the n-th cascade, R_{c,n}=R_{n,m}_{_{c}} (σ_{n,m}_{_{c}}=σₙ).
   The submergence, H_{s,n}, required by the n-th cascade of the profiles is computed by the formula:

$${H}_{s , n} = \frac{B}{{γ}_{w} } - {σ}_{n} H - {R}_{c , n} \qquad ( 8 )$$

where:
B is the barometric pressure and
γ_{w} is the water specific weight
   Finally, the required submergence, Hₛ, of horizontal Bulb turbine, either with mixed-flow propeller or with axial propeller, is the smallest value of H_{s,n} (Hₛ≦H_{s,n}, n=1, . . . , N)

The results of Hₛ computations for Bulb turbines with axial flow and mixed-flow propellers (shown in FIG. 2) by program INNA using eleven cascades between the discharge ring 9 and and the crown 8 (1-st cascade was along the discharge ring 9 and 11-th cascade was along the crown 8).

In order to compare the best Bulb turbine with axial flow propeller currently being offered by the leading hydro-turbine manufacturers with Bulb turbines with mixed-flow and axial flow propellers with increased value of (Q₁₁)ₒₚₜ I have designed using the program INNA three runners for Bulb turbine with D₁=7.5 m with the assumption that for these turbines ηₘₐₓ=0.92. The results of the best designs with respect to cavitational properties are following.

The Bulb turbine with axial flow propeller with (Q₁₁)ₒₚₜ=2.200 m³/sec, (N₁₁)ₒₚₜ=165.0 rpm, and (L/T)ₚₑᵣ=0.820. This runner was designed in order to find the minimal value of (L/T)ₚₑᵣ providing cavitation free operation with Hₛ=Hₛₘ=−8.230 m.

H_{s,1}=−8.363 m, H_{s,11}=−2.390 m, and Hₛ=−8.363 m

The Bulb turbine with axial flow propeller with (Q₁₁)ₒₚₜ=2.830 m³/sec, (N₁₁)ₒₚₜ=142.0 rpm, and (L/T)ₚₑᵣ=0.925:

H_{s,1}=−12.077 m, H_{s,11}=−12.093 m, and Hₛ=−12.093 m

The Bulb turbine with mixed-flow propeller with (Q₁₁)ₒₚₜ=2.830 m³/sec, (N₁₁)ₒₚₜ=110.0 rpm, and (L/T)ₚₑᵣ=2.000:

H_{s,1}=−8.291 m, H_{s,11}=−2.702 m, and Hₛ=−8.291 m

I expect that the head losses of the commercially available Bulb turbine in comparison with Bulb turbines with increased flow capacity will be approximately the same. It can be shown by the comparison of the head losses in the periphery profiles of these turbines. Assuming Cₚᵣₗ to be the same for the turbines I and turbine II on gets from (7) for these turbines working under the same head:

$$\frac{{[ {( {ζ}_{pr} )}_{p} ]}_{I}}{{[ {( {ζ}_{pr} )}_{p} ]}_{II}} = \frac{{{[ {( L / T )}_{per} {( {W}_{∞} )}_{per}^{3} ]}_{I} [ {( {V}_{z} )}_{per} ]}_{II}}{{{[ {( L / T )}_{per} {( {W}_{∞} )}_{per}^{3} ]}_{II} [ {( {V}_{z} )}_{per} ]}_{I}} \qquad ( 9 )$$

The simple computations using (9) show that (ζₚᵣ)ₚ of commercially available Bulb turbine [(Q₁₁)ₒₚₜ=2.200 m³/sec, (N₁₁)ₒₚₜ=165.0 rpm] is 1.490 times higher than for Bulb turbine with mixed-flow propeller [(Q₁₁)ₒₚₜ=2.830 m³/sec, (N₁₁)ₒₚₜ=110.0 rpm] and 1.534 times higher than for Bulb turbine with axial flow propeller [(Q₁₁)ₒₚₜ=2.830 m³/sec, (N₁₁)ₒₚₜ=142.0 rpm]. It is well known that at optimum the profile head losses in the periphery cascades of the propeller runners are the major head losses in the horizontal Bulb turbine and, therefore, it is safe to assume that ηₘₐₓ is the same for all these three turbines despite the fact that (Q₁₁)ₒₚₜ of commercially available turbine is smaller.

The results of computations of Hₛ and the ζₘₐₓ assessments clearly show that the Bulb turbine with axial flow propeller having (Q₁₁)ₒₚₜ=2.830 m³/sec cannot compete with the the Bulb turbine with mixed-flow propeller and the same (Q₁₁)ₒₚₜ, because it requires a substantial increase in cost of the power house constriction due to 3.7 m increase in absolute value of Hₛ.

The computations by the program ENERGY (developed by me in 2007) show that for the conditions of Fundy Bay tidal power plant with 200 Bulb turbines with (Q₁₁)ₒₚₜ]=2.830 m³/sec produces in the case of ebb generation plant 13.9% more energy per diem then with 200 Bulb turbines with (Q₁₁)ₒₚₜ]=2.200 m³/sec what is equivalent to increase in energy output per year equal 2.7 million megawatt-hours. And in the case of two-way generation plant 23.4% more energy per diem what is equivalent to increase in energy output per year equal 4.5 million megawatt-hours.

So finally the analyses above show that the application of Bulb turbine with mixed-flow propeller and (Q₁₁)ₒₚₜ]=2.830 m³/sec would increase the energy output of the Fundy Bay tidal power plant with 200 units up to 4.5 million megawatt-hours per year in comparison with commercially available Bulb turbines with (Q₁₁)ₒₚₜ]=2.200 m³/sec without additional cost for the plant construction and its equipment.

The another important factor is that the runner rotation of the Bulb turbines with mixed-flow propellers [(N₁₁)ₒₚₜ=110.0 rpm, Nₒₚₜ=50.807 rpm] is 0.667 times slower than of commercially available Bulb turbines [(N₁₁)ₒₚₜ=165.0 rpm, Nₒₚₜ=76.211 rpm] what makes these turbines fish friendlier than the commercially available Bulb turbines

I claim:

1. A hydraulic turbine having a bulb with an electrical generator inside, stay columns supporting said bulb, a conical guide gate apparatus, a turbine shaft, a mixed-flow propeller runner secured to said turbine shaft, a discharge ring, and a draft tube with a draft tube cone;
said conical guide gate apparatus having plurality of wicket gates arranged in a circular array around a central axis with said gates pivotal about pivot axes having bigger than zero acute angle with said central axis;
said wicket gates having the conical shape permitting to them to close the water passages;
said mixed-flow propeller runner having a plurality of runner blades arranged in a circular array around said central axis and a runner crown with said runner blades secured to said runner crown;
said turbine shaft secured to said electrical generator shaft.

2. A hydraulic turbine of claim 1 in which said draft tube is straight.

3. A hydraulic turbine of claim 1 in which said turbine shaft is horizontal.

4. A hydraulic turbine of claim 1 having an exit stay apparatus located after the runner exit and secured to said discharge ring wall.

5. A hydraulic turbine of claim 1 in which said electrical generator located in said bulb is DC generator.
